(19) United States
(12) Patent Application Publication
(10) Pub. No.: US 2008/0201002 A1
(43) Pub. Date: Aug. 21, 2008

(54) Machining Template Based Computer-Aided Design and Manufacture Of An Aerospace Component

(75) Inventors: Darren Paul Crew, Bristol (GB); Colin Malcolm, Bristol (GB)

Correspondence Address: LOWE HAUPTMAN HAM & BERNER, LLP, 1700 DIAGONAL ROAD, SUITE 300, ALEXANDRIA, VA, 22314, US

(73) Assignee: AIRBUS UK LIMITED, Bristol (GB)

(21) Appl. No.: 12/064,879

(22) PCT Filed: Sep. 8, 2006
(86) PCT No.: PCT/GB2006/003328

§ 371 Date: Feb. 26, 2008

(30) Foreign Application Priority Data
Sep. 9, 2005 (GB) 0518435.3

(51) Int. Cl. G06F 17/50; G05B 19/18; G06F 7/00; G06F 17/30

(52) U.S. Cl. 700/98; 700/159; 707/104.1; 707/E17.009

(57) ABSTRACT

A CAD model of a component is designed by means of a CAD system that modifies the shape of the design of the component represented by the CAD model by means of templates held in a database of templates. The templates include machining data concerning the machining actions necessary to effect the alteration, represented by the template, of the shape of a work-piece. The CAD system outputs a computer model of the component comprising not only part geometry data concerning the shape of the component but also machining geometry data concerning the machining actions necessary for manufacturing from a work-piece a component having a shape in accordance with the outputted model of the component. This outputted computer model is then converted into an NC (numeric control) program by means of an NC program conversion module, by extracting NC code sequences from a database, the NC code sequences extracted corresponding to the templates of the UDF library used to design the shape of the CAD model.

### BACKGROUND OF THE INVENTION

The present invention relates to the computer-aided design of a component, and in particular to the computer-aided design and manufacture of an aircraft component.

The designing of aircraft components can be complicated and time-consuming even with the assistance of Computer Aided Design and Computer Aided Manufacture (CAD/CAM) systems. One factor that introduces significant time delays is the necessity to covert the complicated geometry that defines the shape of a component into commands passable by a machine for manufacturing the component. For example, a rib for use in an aircraft wing may have a shape defined by means of CAD data structures that then needs to be converted into numerical control (NC) codes for use by a 5-axis milling machine that, during manufacture of the component, effect movements of the milling machine to machine away material from a solid metal billet to produce the shape of the rib. Such a process is called NC programming and is typically performed manually by an NC programming specialist with the aid of computer software. The process includes converting the shape as defined by the CAD model into manufacturing geometry; that is, information that defines the shape of the component by means of geometries that can be machined during manufacture. The manufacturing geometry is then converted into an NC program.

NC programming of a component can require the shape of the component to be manufactured to differ slightly from the shape of the component as designed in CAD as a result of the limitations of the manufacturing processes to be used. Such changes are usually able to be made without affecting the functional performance of the component, but may sometimes have such an effect, which may require redesigning aspects of the component. Also, such changes can impact the design of other parts of an assembly, of which the component forms only a part, especially other parts that are required to interface directly with the component. Also, such changes often lead to an increase in the mass of the component, which in aircraft design is particularly undesirable.

The present invention seeks to provide a method of designing a component that mitigates at least some of the above-mentioned disadvantages.

### SUMMARY OF THE INVENTION

According to the present invention there is provided a method of designing a component (in particular an aerospace component) to be manufactured from a work-piece by a machine, the method comprising the following steps:

(a) providing a CAD system for designing the shape of a component by means of manipulating a computer model of a work-piece,

(b) providing a database of templates for altering the shape of the model,

(c) providing an initial computer model of a work-piece, and

(d) designing a computer model of the component with the CAD system from the initial model of the work-piece, the designing including a plurality of steps in which the shape of the model is altered by means of using one or more of the templates,

wherein

the templates include machining data concerning the machining actions necessary to effect the alteration, represented by the template, of the shape of a work-piece, and

the method includes a step of the CAD system outputting a computer model of the component comprising data concerning the machining actions necessary for manufacturing from a work-piece a component having a shape in accordance with the outputted model of the component.

Thus, as a result of the designing of the shape of the component comprising the use of templates that include machining data, there is no need for a separate step of generating manufacturing geometry and as such NC programming may be effected more efficiently. As such, the design of a component up to and including producing an appropriate NC program may be effected faster and can be automated to a greater degree than previously achievable with methods of the prior art. Also, the templates may effectively restrict the designing of the shape of the component so as to reduce or avoid the risk of designing a shape of component that is not possible to manufacture with a given machine and tool set. Thus, machining limitations may effectively be taken into account during the design process. The templates may for example include check-rules. Such check-rules may be arranged to ensure that conflicts do not occur, for example conflicts that would otherwise give rise to errors in the computer model, the manufacture or the NC programming of the component.

Each of a plurality of the templates in the database of templates may be a template for altering the shape of the work-piece by means of removing portions of the model of the work-piece. The templates may include data representing the change in shape of the work-piece that would result from carrying out the machining actions on a real work-piece. The templates are preferably designed so that the characteristics of the shape alteration represented by a single template are defined by one or more alterable parameters. Such parameters may for example define the shape and size of aspects of the shape alteration represented by a template. As mentioned above, the templates may include check-rule data. Such check-rule data may for example include check rules that enable the quality and/or integrity of the parameters, for example the values assigned thereto, to be checked.

The machining data of each template advantageously comprises details of the machining geometry necessary to effect the alteration, of the shape of a work-piece, represented by the template. The machining data of at least one template in the database preferably comprises details of the orientation of the machine (including for example the orientation of an axis of a tool of the machine) necessary to effect the alteration, of the shape of a work-piece, represented by the template. The machining data of at least one template in the database preferably comprises the position and direction of motion of a machining part of the machine necessary for effecting the alteration, of the shape of a work-piece, represented by the template. For example, the machining data may comprise drive lines, cutter trace lines or the like. Such machining lines may be of particular use when the shape to be machined has a uniform profile and can be machined by means of moving a machining tool in 3 dimensions with only 3 degrees of freedom (for example, in the x, y and z directions).

The details of the position and direction of motion of a machining part of the machine may include limit geometry. Limit geometry may for example include limit surfaces, limit lines and limit points. Such limit geometry is of greater relevance in cases where cutter trace lines are insufficient to define a shape. Limit geometry may be such that a 5-axis (or greater) tool is required to effect the machining actions represented by the geometry. Using limit geometry to represent machining geometry typically requires more processing and data than using simple drive lines, such as cutter trace lines.

The machining data of at least one template in the database preferably comprises details of which of a plurality of different machining parts is necessary for effecting the alteration, of the shape of a work-piece, represented by the template. The machining parts may for example be in the form of machining tools each having a different gauge and/or profile.

The machining data of at least one template in the database may comprise details of control codes adapted to be used by the machine to effect the machining actions. The machining data included in the computer model outputted may thus comprise control codes, such as NC programming data, needed to manufacture the features represented by the templates. Such control codes may be represented (for example embedded) in the templates such that the computer model includes such control codes before the model is converted into the control codes that are actually used by the machine to effect the machining of the component. For example, when the control codes are generated, the codes may simply be extracted directly from the model.

Alternatively, a conversion step may be required in which the machining data is converted into such control codes, the control codes not being able to be directly extracted from the model or from any of the templates.

The method may further include a step of generating control codes, that are adapted to be used by the machine to effect the machining actions, from the computer model of the component outputted by the CAD system. The generation of such control codes may produce a complete NC program for manufacturing the component. As mentioned above, the generation of such control codes may be effected by means of translating manufacturing data into control codes or by means of using control codes already embedded in the computer model. The generation of the control codes may include a step of extracting sequences of control codes from a database of predetermined sequences of control codes by means of associating parts of the machining data included in the computer model of the component with a corresponding sequence in the database. Each template of the library may be associated with a respective control coding template that is used in such a process.

The CAD system is preferably able to display graphically at least some of the machining data alongside the model of the shape of the component. The CAD system is preferably able to display graphically at least some of the machining data alongside the model of the shape of the work-piece (i.e. an intermediate computer model of the shape of the component, for example in an unfinished state). The graphical display may for example be in the form of a 2-dimensional representation of the 3-dimensional model. The display may comprise a wire-frame representation of the model or a portion thereof. The display may comprise a solid-shaded representation of the model or a portion thereof. The machining data is preferably represented pictorially. Thus, if the machining data includes cutter lines and/or limit surfaces, such lines and surfaces are preferably displayed with (and preferably overlaid on) an image of the computer model of the component or the work-piece as appropriate.

The templates may include separate data representing the change in shape of the work-piece that would result from carrying out the machining actions on a real work-piece. Thus, in such a case, the CAD system does not during the alteration of the shape of the work-piece by means of the use of a template need to calculate separately the effect on the shape of the performance of the machining actions represented by the template.

Preferably the initial computer model of the work-piece is the same as the initial work-piece in reality. The initial work-piece in reality, or the initial computer model of the work-piece, may simply be in the form of a billet. The initial work-piece in reality, or the initial computer model of the work-piece, could of course be in the form of a work-piece that has already been machined to some extent.

The method may include a step in which the CAD system generates the initial computer model of the work-piece. In such a case, the initial computer model of the work-piece may be different from the initial work-piece in reality. For example, the initial work-piece in reality may simply be in the form of a featureless billet of material, whereas the initial computer model of the work-piece may be in the form of a part machined billet, the work-piece having the same general shape as the component to be manufactured. In such a case, the method advantageously includes one or more steps in which the method ascertains the extra machining actions necessary for manufacturing, from the initial work-piece in reality, a component having a shape in accordance with the outputted model of the component. The machining actions are extra in the sense that they differ from those machining actions necessary for manufacturing, from a real work-piece corresponding to the initial computer model of the work-piece, a component having a shape in accordance with the outputted model of the component. Such extra machining actions may for example enable the manufacture of an intermediate form of the component (equivalent to the initial computer model of the work-piece) from a cuboid-shaped billet of material. The initial computer model may include the manufacturing data needed for the method to generate such extra machining actions.

The generation of the initial computer model of the work-piece may include performing calculations with the CAD system using inputs concerning the physical and mechanical requirements of the work-piece. The generation of the initial computer model of the work-piece preferably includes the CAD system taking into account the geometry of other parts of a larger object of which the component forms a part. The physical and mechanical requirements inputted may include details of master geometry, for example including the geometry of other parts of an assembly of which the component forms a part. By way of example, in the case where the component is a rib for use in an aircraft wing box, the master geometry may include details of the wing surface, stringer datums, and rib datums. The physical and mechanical requirements inputted may include details of interface geometry, that is the way in which the component must interface with adjacent parts of an assembly of which the component forms a part. Stress requirements may be included. Strength requirements may be included.

By way of example, in relation to the designing of a rib, the generation of the initial computer model of the work-piece may include generating a rib specification model in view of design and stress requirements, and system interfaces such as stringer lines and spar joint schemes.

The generation of the initial computer model of the work-piece may take into account various design rules, such as minimum requirements of the component. The design rules may also reflect limitations of the machining actions able to be effected. Such limitations may for example include limits imposed by the size and shape of useable machining tools, cliff edge limits and maximum and minimum machining steps.

The method is of particular application in relation to the design of components required to perform a structural function, especially in relation to applications where unnecessary extra mass is an issue, such as in the aircraft industry. The invention thus has particular application in relation to aerospace component manufacture and design. The component may be a structural component, for example a component that performs a structural function in an aircraft or a part thereof. The structural component may be a rib or a spar, or a part thereof. The component may have a mass greater than 1 Kg, and possibly greater than 10 Kg. The component may be shaped such that its longest dimension is greater than 100 mm, and possibly greater than 1000 mm.

The component is preferably treated in a modular manner. The method may for example include dividing the component into sub-modules and then performing the method in relation to each such sub-module. Such a modular treatment can assist in the formation of a sufficiently detailed database of templates and facilitates the use of object-oriented design.

Preferably, the CAD system automatically performs a plurality of steps in which the shape of the model is altered by means of using one or more of the templates.

For example, the method may include a step of automatically including in the initial computer model details of the machining actions necessary for manufacturing from a work-piece a component having a shape in accordance with the initial computer model of the work-piece (the initial computer model of the work-piece, which may be in the form of a part-formed component differing from the initial work-piece in reality, which may be in the form of a billet of material for example). Alternatively, or additionally, the initial computer model may be further altered by the CAD system by means of using one or more templates in view of previously supplied design requirements.

The method may include one or more steps that generate automatically a preliminary, or complete, component configuration model, such as a rib configuration model, for example.

Alternatively or additionally, a user may manually use one or more templates to alter the shape of the computer model.

The computer model of the component preferably includes data concerning the positions of certain identifiable features on the component to allow a component-measuring machine to measure the accuracy of the machining of the component. The component-measuring machine may be in the form of a Coordinate Measuring Machine (CMM). Such identifiable features may be in the form of points.

The method may of course further include a step of manufacturing a component in accordance with the outputted model of the component. Thus, according to a second aspect of the present invention there is provided a method of manufacturing a component including the following steps:

(a) providing a machine for machining the component from a work-piece,

(b) performing a method of designing the component to be manufactured from the work-piece by the machine by means of a method according to the first aspect of the present invention, thereby producing a computer model of the component comprising machining data,

(c) providing a work-piece, and

(d) altering the shape of the work-piece by machining it with the machine in accordance with the machining data included in the computer model of the component to manufacture a component having a shape in accordance with the model of the component.

The method may further include a step using a coordinate measuring machine (CMM) to assess the accuracy of the machining of the component by means of using data concerning the positions of certain identifiable features on the component, details of which having been incorporated during the designing of the component by means of the first aspect of the present invention.

According to a third aspect of the present invention there is provided a CAD system programmed to design a component to be manufactured from a work-piece by a machine, the CAD system including:

a memory in which there is stored a database of templates for altering the shape of a computer model of the work-piece, and

a processor programmed to facilitate alteration of the shape of a computer model of a work-piece by means of using one or more of the templates,

wherein

the templates include machining data concerning the machining actions necessary to effect the alteration, represented by the template, of the shape of a work-piece, and

the processor is programmed to output a computer model of the component comprising data concerning the machining actions necessary for manufacturing from a work-piece a component having a shape in accordance with the model of the component.

The present invention also provides a software product suitable for programming a computer processor to form the processor of the third aspect of the present invention.

According to a fourth aspect of the present invention there is provided a software product for programming a processor of a CAD system for designing a component to be manufactured from a work-piece by a machine, wherein the software product includes an application for generating a computer model of a component, the model comprising data concerning the machining actions necessary for manufacturing from a work-piece a component having a shape in accordance with the model of the component, the software product being so configured that in use the computer model of the component is generated from a computer model of a work-piece that has been altered by means of using one or more pre-defined templates, the templates including machining data concerning the machining actions necessary to effect the alteration, represented by the template, of the shape of a work-piece.

The software product preferably includes an application that facilitates the alteration of a computer model of a work-piece by means of using one or more pre-defined templates, the templates including machining data concerning the machining actions necessary to effect the alteration, represented by the template, of the shape of a work-piece.

The computer model of the work-piece that has previously been altered by means of using one or more pre-defined templates may be generated by means of, or with the use of, the software. Thus, the software product may include an application that facilitates the alteration, whether automatically or manually, of a computer model of a work-piece by means of using one or more pre-defined templates, the templates including machining data concerning the machining actions necessary to effect the alteration, represented by the template, of the shape of a work-piece.

According to a fifth aspect of the present invention there is provided a database product comprising a plurality of templates for use by a CAD system for designing the shape of a component by means of manipulating a computer model of a work-piece, wherein each template includes:

shape data representing an alteration of the shape of the computer model, and

machining data concerning the machining actions necessary for a machine to effect the alteration, represented by the template, of the shape of a work-piece.

The database product is preferably suitable for use as the database of templates of any aspect of the present invention described herein. As such, the templates may for example each include one or more parameters (for example parameters that are alterable by the user) that define key geometries represented by the template. Such parameters may for example define the shape and size of aspects of the shape alteration represented by a template. The templates may also include check-rules as described herein.

According to a sixth aspect of the present invention there is provided a data structure in the form of a template for use by a CAD system for designing the shape of a component by means of manipulating a computer model of a work-piece, wherein the template includes:

shape data representing an alteration of the shape of the computer model, and

machining data concerning the machining actions necessary for a machine to effect the alteration, represented by the template, of the shape of a work-piece.

The above software product, database product and data structure is conveniently provided in electronic form.

### DESCRIPTION OF THE DRAWINGS

An embodiment of the present invention will now be described, by way of example only, with reference to the accompanying drawings of which:

FIG. 1 is a flow diagram showing processes and data used in a method of designing a rib for an aircraft wing-box,

FIG. 2 is a graphical representation of a preliminary CAD model of the rib,

FIG. 3 is a flow diagram illustrating the processes used to produce the body of the rib of the CAD model shown in FIG. 2,

FIG. 4 shows schematically a model of a rib and various user-defined templates that have been used to create parts of the shape of the rib,

FIGS. 5a to 5h show part and manufacturing geometry of the rib and parts thereof, and

FIG. 6a and 6b together form a flow-chart that summarises the design of the rib by means of parallel rib body and rib feet design processes.

### DETAILED DESCRIPTION

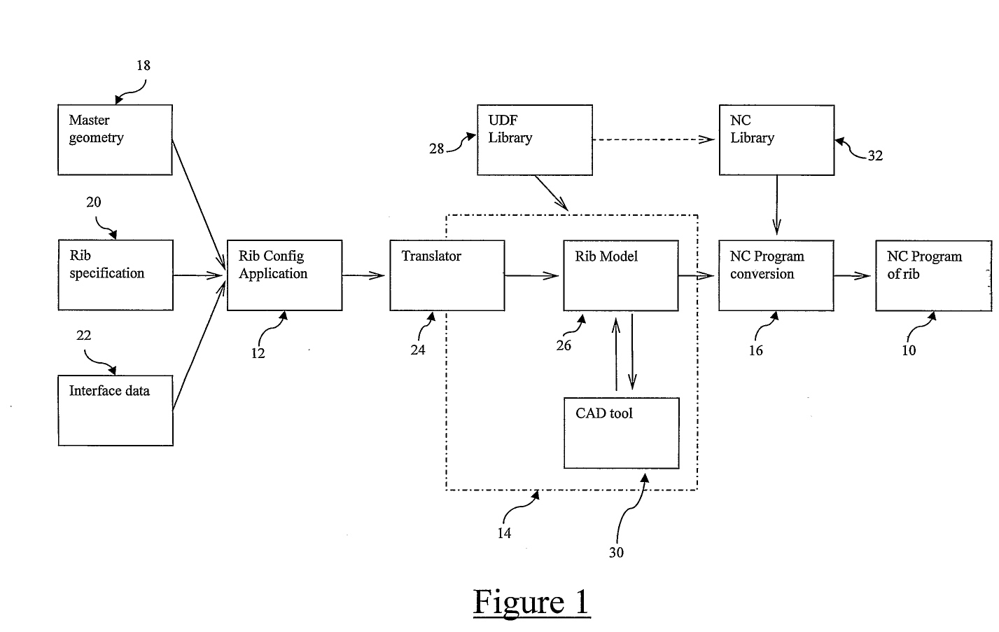

FIG. 1 shows a schematic overview of the processes and data used for generating an NC (numeric control) program 10 for machining a rib for an aircraft wing-box in accordance with an embodiment of the invention. The processes represented in FIG. 1 can be divided into three software modules, namely a rib configuration application module 12, a CAD system module 14, which allows an operator to manipulate the preliminary model of the rib to produce a detailed computer-model of the rib (including details of the final desired shape of the rib) and an NC programming module 16, which converts the detailed computer-model of the rib into an output in the form of a complete NC program 10 for manufacturing the rib.

The rib configuration module 12 is implemented by means of a KBE (knowledge-based engineering) CAD package named ICAD available from the French company Dassault Systèmes (the software originally being developed by Knowledge Technologies International also known as KTI). The inputs to the rib configuration module 12 comprise master geometry data 18 concerning details such as the shape of the wing skin, stringer datums and rib datums, a rib specification file 20 including data concerning the design and stress requirements of the rib and interface data 22 concerning interface details such as system centre lines, and spar joint schemes.

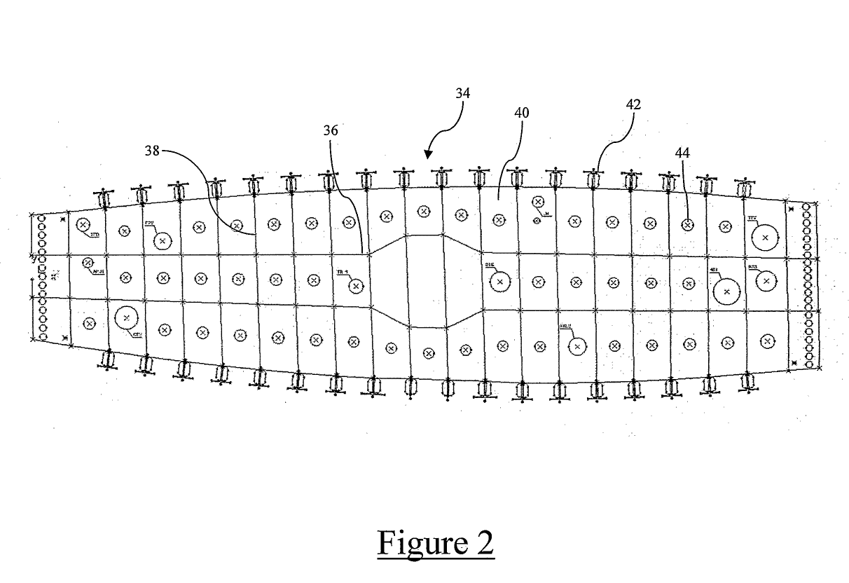

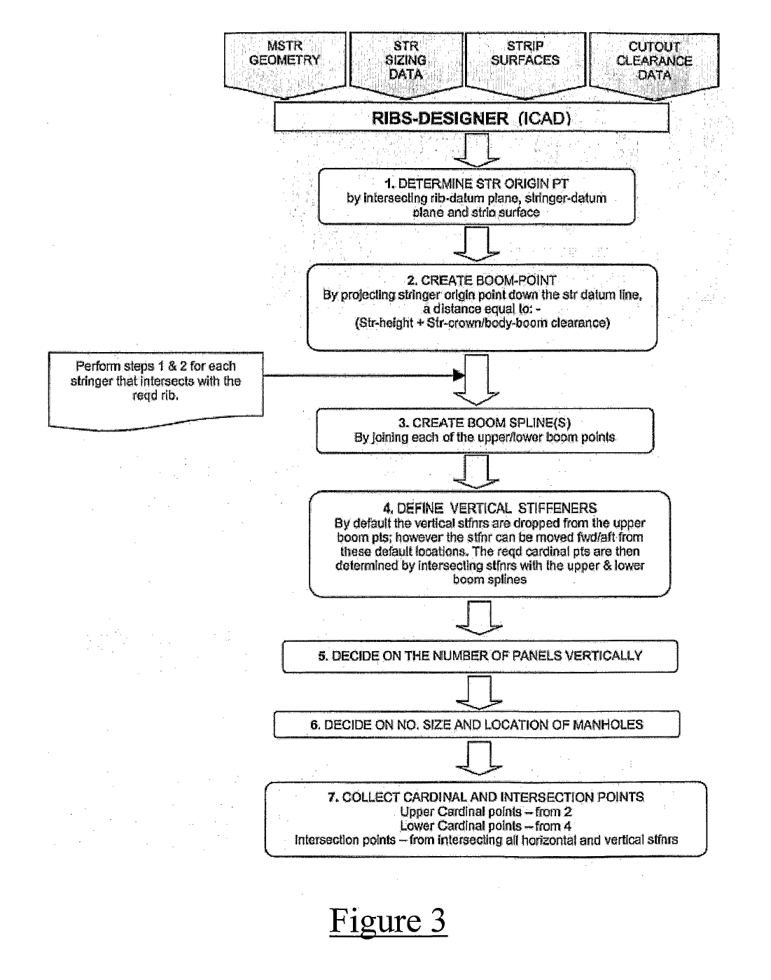

The rib configuration module 12 processes these inputs to construct a preliminary rib model in view of pre-programmed knowledge concerning the design and manufacture of ribs (using standard knowledge based engineering techniques). The rib configuration module 12 outputs an object-oriented (feature-based) file, as an ICAD data structure, concerning the preliminary wire-frame design of the rib and includes details such as cardinal points and datums. The cardinal points of the rib body are generated by the rib configuration module 12 by means of the method illustrated by the flowchart of FIG. 3. The cardinal points so generated define a positional sketch of the rib and include spar bolting positions, tooling hole positional points, system hole positional points and lightening hole positional points. The datums generated by the rib configuration module 12 include front and reverse rib datum planes, and front and reverse billet limit planes. FIG. 3 shows only those steps needed to produce the positional sketch of the rib body, there being an equivalent process used to generate the corresponding sketch for the rib feet. The data included in the file generated by the rib configuration module 12 is represented graphically in FIG. 2, which shows a wire-frame model 34 of the rib. This preliminary wire-frame design subsequently forms the basis of the detailed computer-model of the solid rib. As such, the preliminary wire-frame model 34 defines the general shape of the rib, the positions of the horizontal stiffening members 36 (including the top and bottom booms) and vertical stiffening members 38 that define the pockets 40 of the rib, the locations of the stringers 42 and the locations of system holes 44.

The object-oriented file concerning the preliminary wire-frame design of the rib is received by the CAD system module 14. The CAD system module 14 is implemented in part by means of a software package named Catia V5 (available from and developed by Dassault) and uses Catia V5 data structures. As a result the data structures outputted by the rib configuration module 12 are not immediately native to the CAD system module 14. The CAD system module 14 thus comprises a translator interface 24 that converts the object-oriented ICAD file received from the rib configuration application 12 into a hybrid design and manufacturing rib model in a data structure compatible with Catia V5. The hybrid rib model not only defines the shape of the rib represented by the model but also includes all the manufacturing geometries sufficient to manufacture a rib having that shape. The hybrid rib model is created by the translator interface 24 by means of utilising a library of design feature templates 28 in the form of Catia V5 compatible data structures. ICAD features represented in the preliminary model are thus converted into Catia V5 features with additional manufacturing geometry. The library 28 is effectively a predefined suite of User Defined Features and is referred to hereinafter as the UDF library 28, the templates of which being referred to as UDF templates.

This hybrid rib model may be further amended and manipulated by a user-operated CAD tool 30 (implemented in Catia V5) by means of certain allowable alterations proscribed by the UDF library 28. The alteration of the hybrid model is effected by means of removal of material from the model, the shape of the material being removed being defined by means of the UDF templates of the UDF library 28.

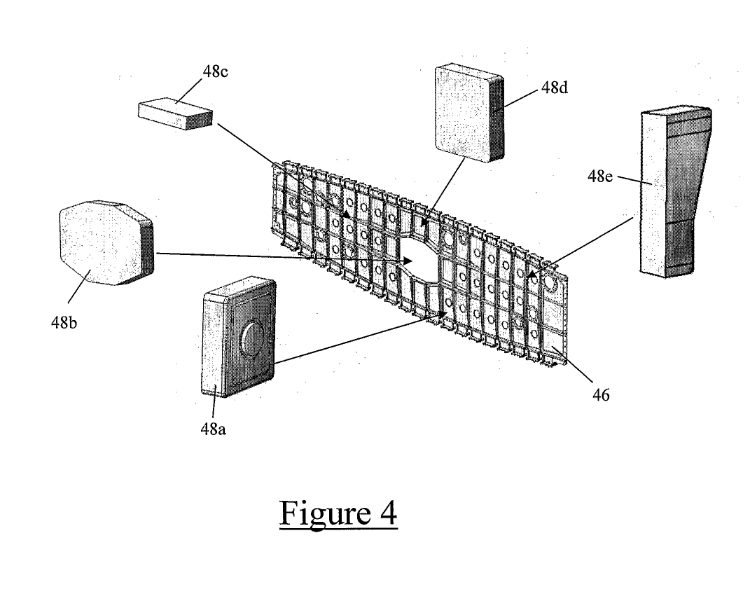

FIG. 4 shows a 3-D solid representation of the hybrid model 46 (showing only the shape of the rib and excluding the manufacturing geometry included in the hybrid model for the sake of clarity) and the various templates 48 that have been used to remove material from the model to create the shape shown. Thus, the templates 48 may include features such as a pocket 48a including a lightening hole, a manhole 48b, a horizontal ramp 48c, a simple pocket 48d, and a vertical ramp 48e. Each UDF template includes not only details of the geometry of the shape of the material to be removed, but also manufacturing geometry including the geometry of the processes needed to effect removal of the material.

The manufacturing geometry data includes details of tool drive geometry in the form of cutter trace lines, cutter tool axis orientation, drive lines, and limit geometry (such as limit points, limit lines, limit surfaces or guide surfaces). Cutter trace lines are typically used to define manufacturing geometry when the shape to be machined is in the form of a surface able to be machined with a 3-axis milling machine (such as a flat surface), where one-dimensional (i.e. straight-line) cutting can be employed. Limit geometry and in particular limit surfaces (that is surfaces that collectively define the shapes to be machined) are typically used to define manufacturing geometry when the shape to be machined is more complex and which may necessitate 5-axis machining.

The manufacturing geometry data takes account of design rules, such as cliff-edge calculations relating to the profile of the cutting effected by the machining tools that are used in manufacturing and such as the maximum/minimum steps able to be effected by a machining tool. The manufacturing geometry data also includes check geometry in the form of particular planes, edges and/or points that after manufacture are checked (with a Coordinate Measuring Machine or CMM) to assess the accuracy of the manufacture in relation to the CAD model of the rib.

The UDF templates 48 are fully scalable and are parameterised to allow each feature to be adapted by the user to be implemented in a multiplicity of different ways. Thus, for example, a pocket 48a including a lightening hole may have an adjustable hole diameter, an adjustable thickness and an adjustable width and length.

The generic features represented in the UDF library 28 can typically be used to define 95% of the structure (part and manufacturing geometry) of the rib. The remaining 5% of the structure needs to be defined by non-generic features. Such non-generic features are generated and inserted into the hybrid computer model manually by means of defining a profile and using a UDF non-generic feature tool that allows the profile to be translated into part and manufacturing geometry.

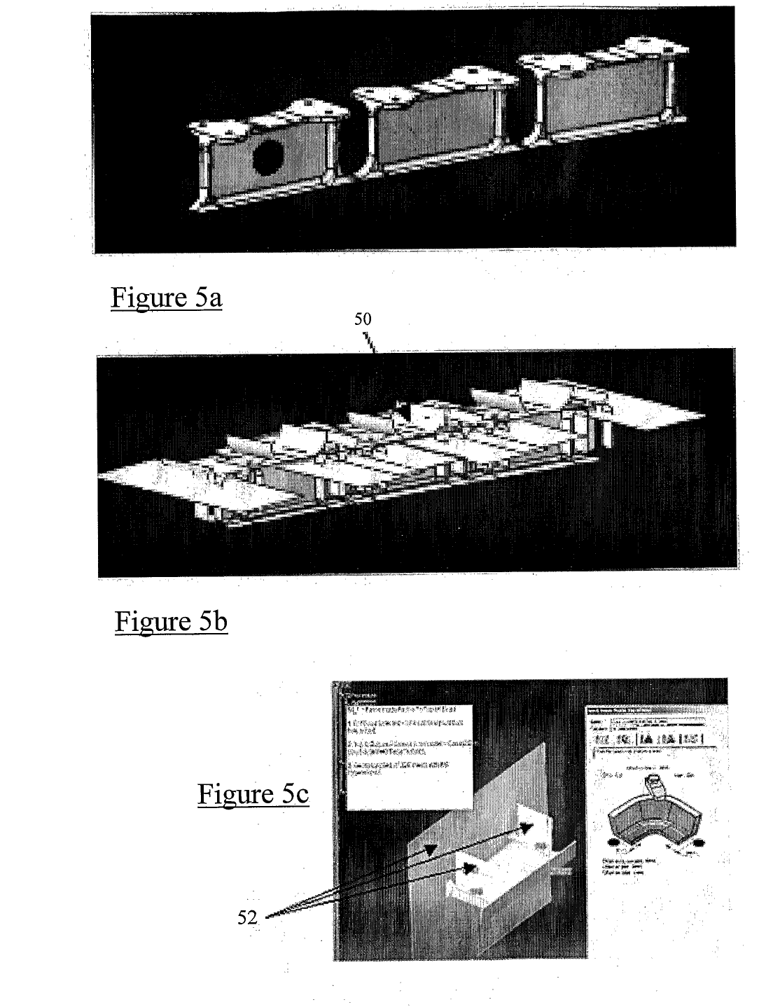

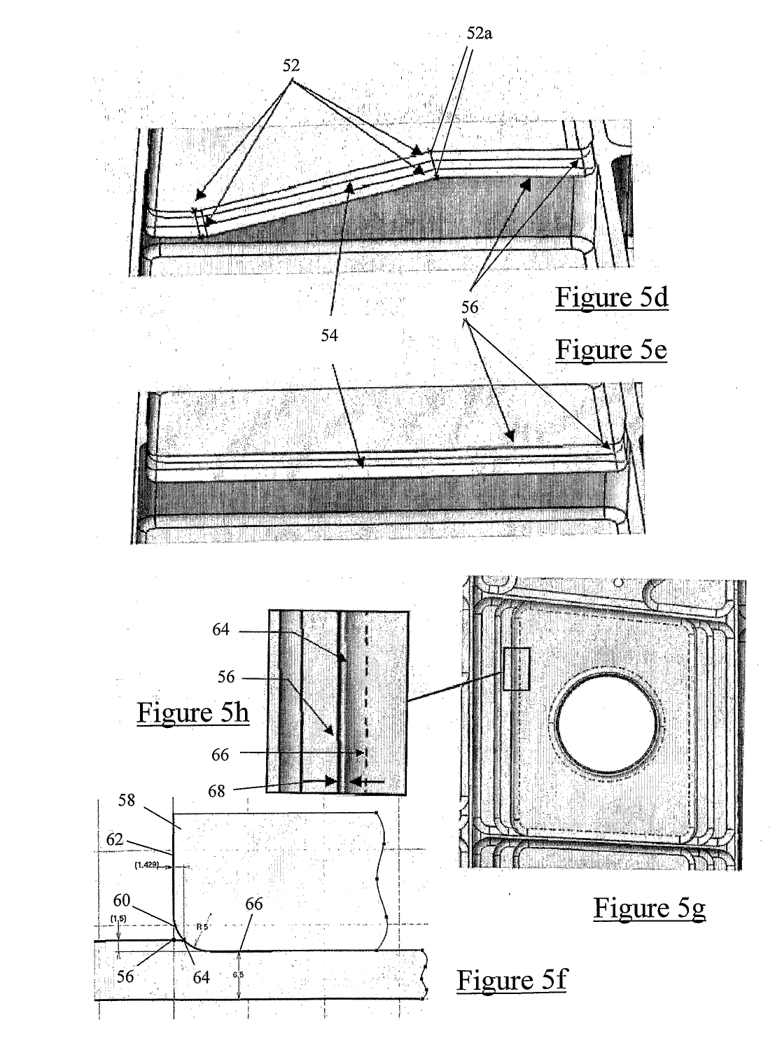

The manufacturing geometry embedded in the UDF templates and therefore also in the hybrid model will now be briefly explained with reference to FIGS. 5a to 5h. FIG. 5a shows the shape of three rib feet without the manufacturing geometry being shown, whereas FIG. 5b shows the same rib feet with certain manufacturing geometries including curved limit surfaces 50. Such curved surfaces would need to be machined with the use of a 5-axis milling machine. FIG. 5c shows a single rib foot with three planar limit surfaces 52. FIGS. 5d and 5e each show a wall of a pocket of the rib and the associated limit geometry 52 including limit points 52a, the part geometry 54 and the drive geometry 56. The two pairs of limit points 52a shown in FIG. 5d define the start and end of each of two lines which themselves define the start and end of a slope. The drive line 56 defines a shallow U shape and marks the start and end of the area of the limit surface 52 that needs to be machined as well as the direction of the cutter. The limit surface 52, limit lines 52a and drive line 56 together represent sufficient manufacturing geometry to enable NC control codes to be generated to machine the slope between the limit lines 52a. FIG. 5f shows schematically the profile of a milling tool 58 and illustrates how the tool is unable to machine away a clean edge, in view of the radius R₅ of curvature of the corner 60 of the tool. The curvature of the tool 60 means that the depth of material cut away by the tool varies with distance away from the edge 62 of the tool towards the axis of the tool 58, the edge 62 of the tool following during manufacture the cutter trace line 56 of the drive geometry. The actual profile of the cutting action effected by the tool thus defines a cliff-edge, which needs to be accounted for when converting a CAD model into manufacturing geometry. The present embodiment automatically accounts for cliff-edge correction by means of the UDF templates. FIG. 5g shows a pocket of a rib and FIG. 5h shows a part of FIG. 5g magnified for the sake of clarity. In FIG. 5h, there are shown a first line 64 representing the hard edge (the top of the cliff edge) to be manufactured in accordance with the sketch line defined by the hybrid model geometry, and a second line 56 representing the cutter trace line. A third line 66 is also shown which is not needed in order to enable NC programming, but may be considered as representing the bottom of the cliff edge. The positions of these three lines 56, 64, and 66 relative to the milling tool are shown in FIG. 5f. The cliff edge correction is the difference 68 between the configuration sketch line (the position of the edge 64 as defined in the CAD model) and the cutter trace line 56 used to form that edge 64 during manufacture.

The manufacturing geometry is labelled in the CAD model as such to distinguish between part and manufacturing geometry and to facilitate the conversion of the CAD model into NC programming code.

Referring back to FIG. 1, after amendment of the hybrid rib model has been completed to the satisfaction of the user, the model is outputted from the CAD system module 26 and received by the NC programming module 16. The hybrid model comprises sufficient manufacturing geometry for making the component, the manufacturing geometry having been created by means of the use of the UDF library 28. The NC programming module 16 converts the manufacturing geometry embedded in the hybrid model into a complete NC program 10 by means of using a library 32 of NC processes, that includes NC data for the manufacturing geometries included in the UDF templates. The NC library is populated by means of previously supplied data that relates the UDF templates to NC sub-programs, so that the NC programming module 16 is able to search and retrieve NC sub-programs from the library 32 in respect of each aspect of the rib that is provided by means of a UDF template.

The NC program 10 is then able to be used to program a 5-axis robot provided with a milling tool to manufacture a rib according to the final computer model of the rib from a billet. After manufacture of the rib, CMM is performed by means of using the CAD model, which as described above already includes details of CMM recognisable points/features that can be referenced directly back to the CAD model.

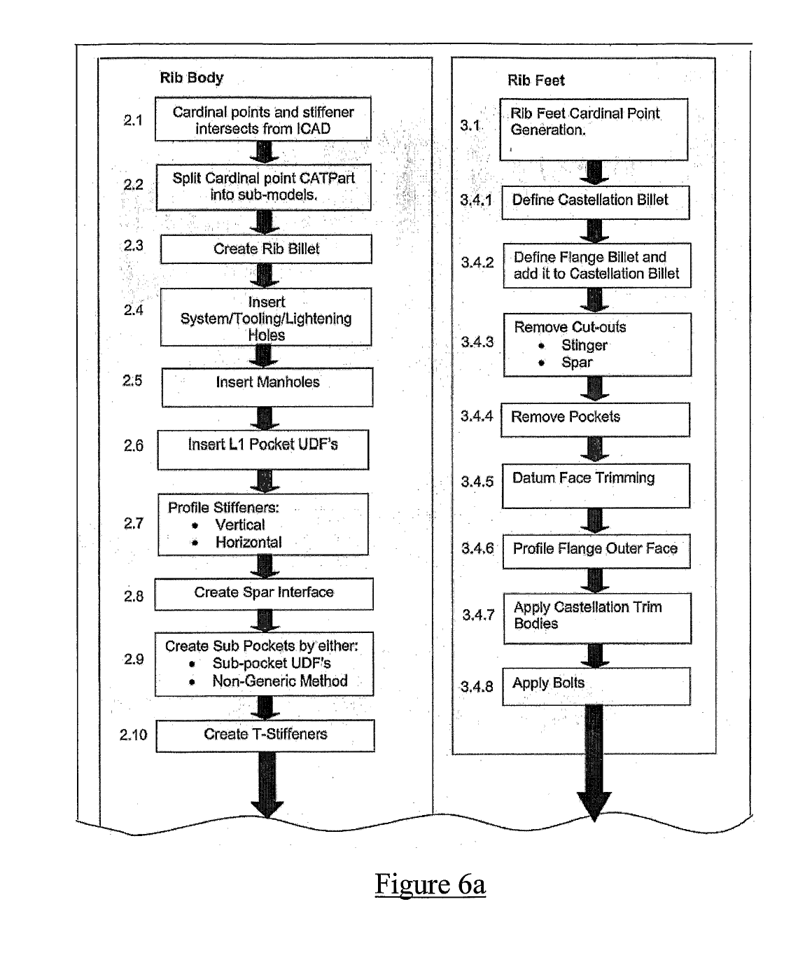

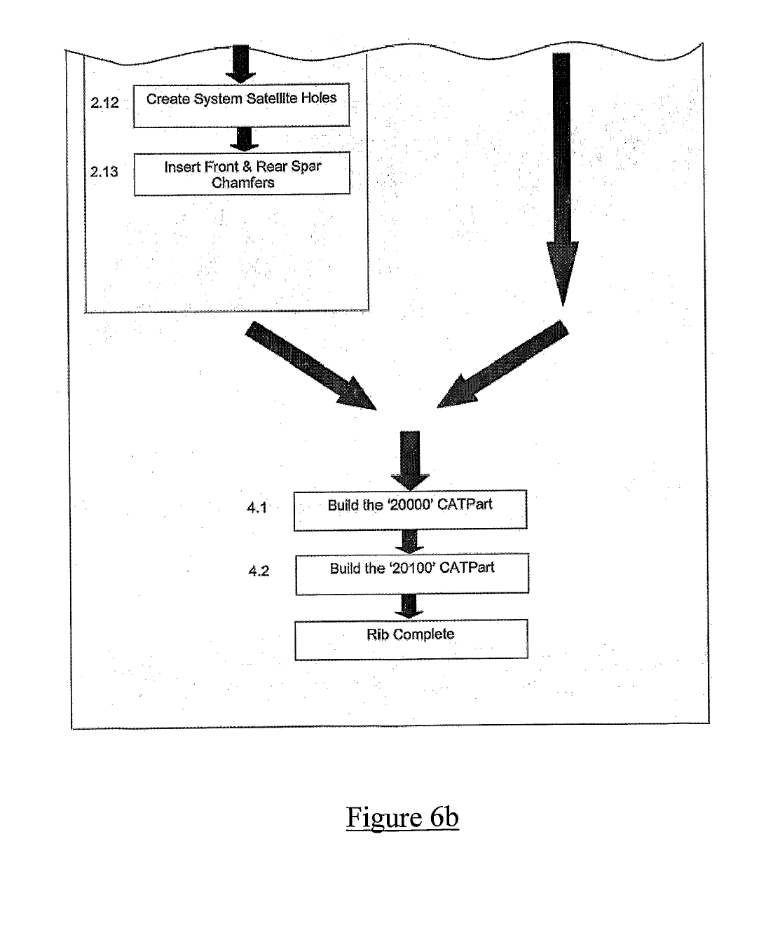

In this particular embodiment the shape and function of the rib is divided into modules including a rib-body module and a rib-feet module. The rib-body module is further sub-divided into further sub-modules including pockets, stiffeners, manholes, other holes and further generic and non-generic features. The rib-feet module is further sub-divided into further sub-modules including cut-outs, pockets, holes, trim features, and further generic and non-generic features. The design process for producing a rib is illustrated by the flow chart represented by FIGS. 6a and 6b, which shows the process from the point at which cardinal points have been automatically generated, through the manual definition of various design features incorporated into the CAD model by means of using the UDF templates, to the generation of a complete Catia V5 output file including all NC programming data necessary to make the rib. In FIG. 6b, there is a step (4.1) labelled “Build the ‘20000’ CATPart”. This step relates to creating a CATIA V5 data structure that defines the rib in the left wing of an aircraft. The step (4.2) labelled “Build the ‘20100’ CATPart” relates to creating a CATIA V5 data structure that defines the rib in the right wing of an aircraft and is performed by means of a simple symmetry operation.

Whilst the present invention has been described and illustrated with reference to particular embodiments, it will be appreciated by those of ordinary skill in the art that the invention lends itself to many different variations not specifically illustrated herein. By way of example, certain variations to the above-described embodiments will now be described.

The modules of the above-described embodiment are implemented by means of different software packages including ICAD and Catia V5. It will be appreciated that the embodiment could be implemented by means of one software package, which could be a bespoke software package or could be implemented using an existing platform such as Catia V5.

It will also be appreciated that whilst the above-described embodiment relates to the design and manufacture of a rib, the present invention has application in relation to other aerospace components, particularly structural components of the aircraft (that is components configured to perform a structural function in the assembled aircraft).

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims.

1. A method of designing an aerospace component to be manufactured from a work-piece by a machine, the method comprising the following steps:
(a) providing a CAD system for designing the shape of an aerospace component by means of manipulating a computer model of a work-piece,
(b) providing a database of templates for altering the shape of the model,
(c) providing an initial computer model of a work-piece, and
(d) designing a computer model of the aerospace component with the CAD system from the initial model of the work-piece, the designing including a plurality of steps in which the shape of the model is altered by means of using one or more of the templates,
wherein
the templates include machining data concerning the machining actions necessary to effect the alteration, represented by the template, of the shape of a work-piece, and
the method includes a step of the CAD system outputting a computer model of the aerospace component comprising data concerning the machining actions necessary for manufacturing from a work-piece an aerospace component having a shape in accordance with the outputted model of the aerospace component.

2. A method according to claim 1, wherein each of a plurality of the templates in the database of templates is a template for altering the shape of the work-piece by means of removing portions of the model of the work-piece.

3. A method according to claim 1, wherein the machining data of each template comprises details of the machining geometry necessary to effect the alteration, of the shape of a work-piece, represented by the template.

4. A method according to claim 1, wherein the machining data of each template comprises details of the orientation of the machine necessary to effect the alteration, of the shape of a work-piece, represented by the template.

5. A method according to claim 1, wherein the machining data of each template comprises details of the position and direction of motion of a machining part of the machine necessary for effecting the alteration, of the shape of a work-piece, represented by the template.

6. A method according to claim 5, wherein the details of the position and direction of motion of a machining part of the machine include limit geometry.

7. A method according to claim 1, wherein the machining data of each template comprises details of which of a plurality of different machining parts is necessary for effecting the alteration, of the shape of a work-piece, represented by the template.

8. A method according to claim 1, wherein the machining data of each template comprises details of control codes adapted to be used by the machine to effect the machining actions.

9. A method according to claim 1, wherein the method further includes a step of generating control codes, that are adapted to be used by the machine to effect the machining actions, from the computer model of the aerospace component outputted by the CAD system.

10. A method according to claim 9, wherein the generation of the control codes includes a step of extracting sequences of control codes from a database of predetermined sequences of control codes by means of associating parts of the machining data included in the computer model of the aerospace component with a corresponding sequence in the database.

11. A method according to claim 1, wherein the CAD system is able to display graphically at least some of the machining data alongside the model of the shape of the work-piece or component.

12. A method according to claim 1, wherein the method includes a step in which the CAD system generates the initial computer model of the work-piece.

13. A method according to claim 12, wherein the generation of the initial computer model of the work-piece includes performing calculations with the CAD system using inputs concerning the physical and mechanical requirements of the work-piece.

14. A method according to claim 12, wherein the generation of the initial computer model of the work-piece includes the CAD system taking into account the geometry of other parts of a larger object of which the aerospace component forms a part.

15. A method according to claim 1, wherein the CAD system automatically performs a plurality of steps in which the shape of the model is altered by means of using one or more of the templates.

16. A method according to claim 1, wherein the computer model of the aerospace component includes data concerning the positions of certain identifiable features on the aerospace component to allow a coordinate measuring machine to measure the accuracy of the machining of the aerospace component.

17. A method according to claim 1, wherein the aerospace component is a component of a type required to perform a structural function.

18. A method according to claim 1, wherein the aerospace component is an aircraft rib.

19. A method of manufacturing an aerospace component including the following steps:
(a) providing a machine for machining the aerospace component from a work-piece,
(b) performing a method of designing the aerospace component to be manufactured from the work-piece by the machine by means of a method according to any preceding claim, thereby producing a computer model of the aerospace component comprising machining data,
(c) providing a work-piece, and
(d) altering the shape of the work-piece by machining it with the machine in accordance with the machining data included in the computer model of the aerospace component to manufacture an aerospace component having a shape in accordance with the model of the aerospace component.

20. A method according to claim 19, when dependent on claim 16, wherein the method further includes a step using a coordinate measuring machine to assess the accuracy of the machining of the aerospace component by means of using the data concerning the positions of the identifiable features on the aerospace component.

21. A CAD system programmed to design an aerospace component to be manufactured from a work-piece by a machine, the CAD system including:
a memory in which there is stored a database of templates for altering the shape of a computer model of the work-piece, and
a processor programmed to facilitate alteration of the shape of a computer model of a work-piece by means of using one or more of the templates,
wherein
the templates include machining data concerning the machining actions necessary to effect the alteration, represented by the template, of the shape of a work-piece, and
the processor is programmed to output a computer model of the aerospace component comprising data concerning the machining actions necessary for manufacturing from a work-piece an aerospace component having a shape in accordance with the model of the aerospace component.

22. A software product for programming a processor of a CAD system for designing an aerospace component to be manufactured from a work-piece by a machine, wherein the software product includes an application for generating a computer model of an aerospace component, the model comprising data concerning the machining actions necessary for manufacturing from a work-piece an aerospace component having a shape in accordance with the model of the aerospace component, the software product being so configured that in use the computer model of the aerospace component is generated from a computer model of a work-piece that has been altered by means of using one or more pre-defined templates, the templates including machining data concerning the machining actions necessary to effect the alteration, represented by the template, of the shape of a work-piece.

23. A software product according to claim 22, wherein the software product includes an application that facilitates the alteration of a computer model of a work-piece by means of using one or more pre-defined templates, the templates including machining data concerning the machining actions necessary to effect the alteration, represented by the template, of the shape of a work-piece.

24. A database product comprising a plurality of templates for use by a CAD system for designing the shape of an aerospace component by means of manipulating a computer model of a work-piece, wherein each template includes:
shape data representing an alteration of the shape of the computer model, and
machining data concerning the machining actions necessary for a machine to effect the alteration, represented by the template, of the shape of a work-piece.

25. A database product according to claim 24, wherein the shape data of each template includes one or more alterable parameters that define characteristics of the shape alteration represented by the shape data.

26. A database product according to claim 25, wherein each template further includes check-rule data that enables the quality and/or integrity of the values of the parameters to be checked.

27. A data structure in the form of a template for use by a CAD system for designing the shape of an aerospace component by means of manipulating a computer model of a work-piece, wherein the template includes:
shape data representing an alteration of the shape of the computer model, and
machining data concerning the machining actions necessary for a machine to effect the alteration, represented by the template, of the shape of a work-piece.
